(19) United States
(12) Patent Application Publication
(10) Pub. No.: US 2018/0147965 A1
(43) Pub. Date: May 31, 2018

(54) HANDLE ASSEMBLY OF A VEHICLE DOOR

(71) Applicant: Ford Global Technologies LLC, Dearborn, MI (US)

(72) Inventors: Bob Wang, Nanjing (CN); Sophie Yan, Nanjing (CN); Qingsong Ma, Nanjing (CN); Daisy Zhao, Nanjing (CN)

(21) Appl. No.: 15/821,555

(22) Filed: Nov. 22, 2017

(30) Foreign Application Priority Data
Nov. 29, 2016 (CN) 201611074317.5

(51) Int. Cl. B60N 3/02; E05B 85/10; B60R 16/037; B60N 2/00

(52) U.S. Cl. CPC B60N 3/023; B60N 2/002; B60R 16/037; E05B 85/107

(57) ABSTRACT

A handle assembly of a door of a vehicle comprises an auxiliary handle disposed on an inner surface of the door, and moveable between a deployed position and a normal position; a driving device to move the auxiliary handle; and a control device configured to instruct the driving device to move the auxiliary handle based on a door condition.

### RELATED APPLICATION

This application claims the benefit of Chinese Patent Application No.: CN 201611074317.5 filed on Nov. 29, 2016, the entire contents thereof being incorporated herein by reference.

### FIELD

This present application relates to a door handle assembly of a vehicle, particularly, relates to a door handle assembly with a moveable auxiliary handle.

### BACKGROUND

A vehicle door typically includes a handle disposed on its inner surface to assist a driver or a passenger to operate the door when entering or existing the vehicle. The handle is typically fixed on the door. In some circumstances, the handle may be difficult to be reached by the driver or the passenger inside the vehicle when the door is opened. For example, in a large size vehicle such as a truck, a user may need to stretch his/her arm to pull the handle when a door is opened wide. In another example, if a user has a small stature, he or she may need an effort to reach the handle. Thus, the fixed handle may cause inconvenience and affect the user experience in some situations.

### SUMMARY

According to one aspect of the present disclosure, a handle assembly of a door of a vehicle is provided. The handle assembly includes an auxiliary handle disposed on an inner surface of the door and moveable between a deployed position and a normal position; a driving device to move the auxiliary handle; and a control device configured to instruct the driving device to move the auxiliary handle based on a door condition.

In one embodiment, the handle assembly may further comprise a base handle. The base handle may include a base and a cavity in a middle portion of the base to receive a hand. The auxiliary handle may be disposed on the base handle.

In another embodiment, the handle assembly may further comprise a locking sensor to detect the door condition. The control device may be configured to instruct the driving device to move the auxiliary handle based on an open state and a closed state of the door.

In another embodiment, the handle assembly may further comprise a detection unit to detect user information. The user information may include whether a user sits on a seat corresponding to the auxiliary handle.

In another embodiment, the detection unit may be one of a weight sensor and a pressure sensor disposed on a cushion of the seat to obtain information related to a stature of a user.

In another embodiment, the detection unit may include an image sensor to capture an image of user and the control device may estimate a stature of a user based on a captured image from the detection unit.

In another embodiment, the control device may be configured to instruct the driving device to move the auxiliary handle to the deployed state when it determines that the door is at the open state, and instruct the driving device to move the auxiliary handle from the deployed position to the normal position when it determines that the door is changed from the open state to the closed state and the user has sit on the seat based on the information from the locking sensor and the detection unit.

In another embodiment, the handle assembly may further comprise an actuator connected to one of the control device and the driving device. The actuator may be configured to activate movement of the auxiliary handle upon an action from the user.

In another embodiment, the actuator may be disposed on a base of the handle, the door or is integrated on a key fab of the vehicle.

In another embodiment, the auxiliary handle includes a plate having an opening and pivotally connected to the base handle at a side closer to an interior of the vehicle by a spring hinge. The auxiliary handle is rotated between the deployed position and the normal position by the driving device.

In another embodiment, the auxiliary handle may include two legs and a cross bar between the two legs and wherein the two legs are slidable along an inner surface of the cavity of the base. The driving device may include a step motor to extend and retract the auxiliary device between the normal and the deployed positions.

In another embodiment, the detection unit may be a proximation sensor to detect a hand of a user, and the proximation sensor is disposed on the handle.

In another embodiment, the auxiliary handle may be further configured to move between one of the deployed position, the normal position and a middle position between the deployed position and the normal position.

In another embodiment, the auxiliary handle is closer to a user sitting on a seat at the deployed position.

According to another aspect, a method is provided to operate a handle assembly of a door of a vehicle. The handle assembly includes an auxiliary handle, a control device and a driving device. The method comprises detecting a door condition; and actuating the auxiliary handle to move the auxiliary handle to a deployed position or a normal position based on a detected door condition.

In one embodiment, detecting the door condition may include detecting an opening state or a closed state of the door.

In another embodiment, actuating the auxiliary handle may include moving the auxiliary handle to the deployed position when it is determined that the door is opened.

In another embodiment, the method may further comprise detecting user information, and actuating the auxiliary handle is further determined based on detected user information.

In another embodiment, the user information may include a stature of a user.

In another embodiment, the user information includes whether the user has sit on a seat of the vehicle corresponding to the auxiliary handle.

The handle assembly of the present disclosure can assist a user to reach a handle on a vehicle door. In some embodiment, an auxiliary handle can be activated to a deployed position closer to the user automatically based on the need of the user. In some embodiments, the auxiliary handle can also be activated by the user via an actuator.

### BRIEF DESCRIPTION OF DRAWINGS

Example embodiments will be more clearly understood from the following brief description taken in conjunction with the accompanying drawings. The accompanying drawings represent non-limiting, example embodiments as described herein.

FIG. 1 is a partial view of a vehicle, illustrating a handle assembly of a vehicle door according to one embodiment of the present invention

FIG. 2 is a block diagram of a handle assembly of a vehicle door according to one embodiment of present invention;

FIGS. 3A and 3B are schematic views of a handle assembly of a vehicle door according to one embodiment of the present disclosure, illustrating an auxiliary handle at a normal position and a deployed position, respectively.

FIGS. 4A and 4B are schematic views of a handle assembly of a vehicle door according to another embodiment of the present disclosure, illustrating an auxiliary handle at a normal position and a deployed position, respectively.

FIG. 5 is a flow chart of a method to operate an auxiliary handle of a handle assembly of a vehicle door.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

The disclosed door handle assemblies of a vehicle and methods to operate the handle assemblies will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various handle assemblies and methods to operate the handle assemblies are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

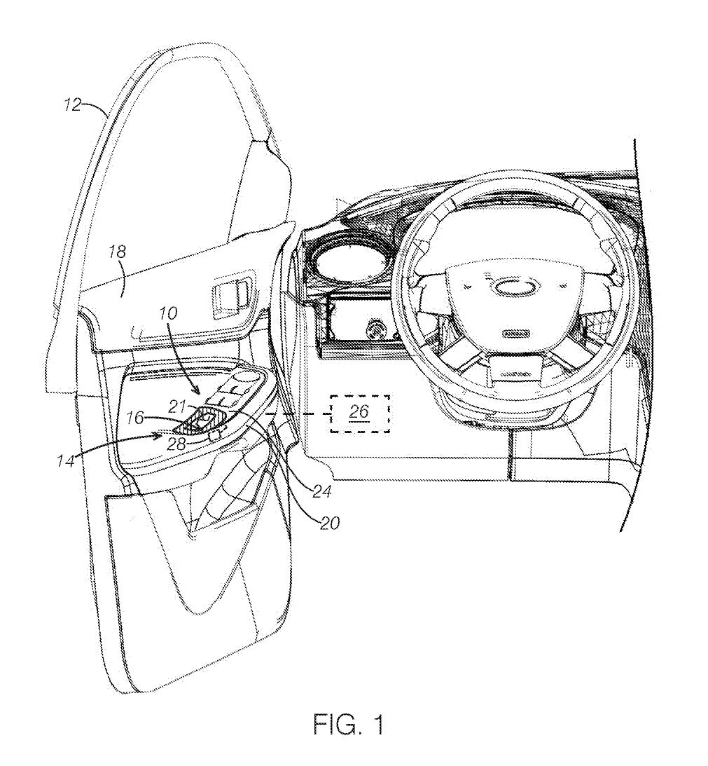

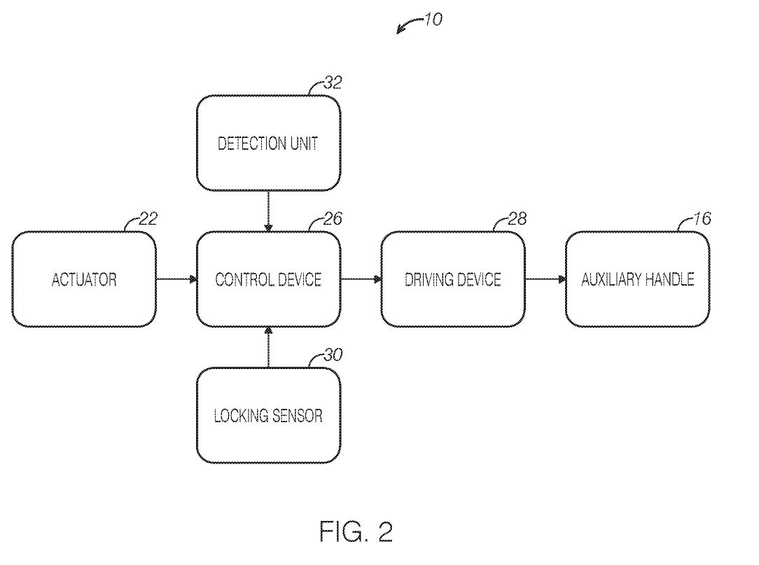

Referring to FIG. 1 and with further reference to FIG. 2, the present disclosure provides a handle assembly 10 of a vehicle door 12. The handle assembly 10 includes a base handle 14 and an auxiliary handle 16. The base handle 14 and the auxiliary handle 16 are disposed on an inner surface 18 of the vehicle door 12. In the depicted embodiment, the base handle 14 includes a base 20 and a cavity 21 formed in the base 20. The base 20 may protruded from the inner surface 18 of the vehicle door and may be used to support an arm as an arm rest. In some embodiments, the base 20 may be a portion of door decoration of an inner trim of the vehicle door 12. The cavity 21 may be configured to receive a user's hand such that the user can grab the base handle 14 to operate the door (e.g., open and close the door 12). The auxiliary handle 16 is moveably connected to the base handle 14 and can move from a normal position to a deployed position and vice versa. In some embodiments, the auxiliary handle 16 may be disposed on an upper surface 24 of the base 20. The auxiliary handle 16 may have a looped shape with an opening to receive a user's fingers. At the normal position shown in FIG. 1, the auxiliary handle 16 overlaps on the base handle 14 while exposing the cavity 21 so that the base handle can be used for opening and closing the door 12. It should be appreciated that the base handle 14 and the auxiliary handle 16 may have any appropriate configurations.

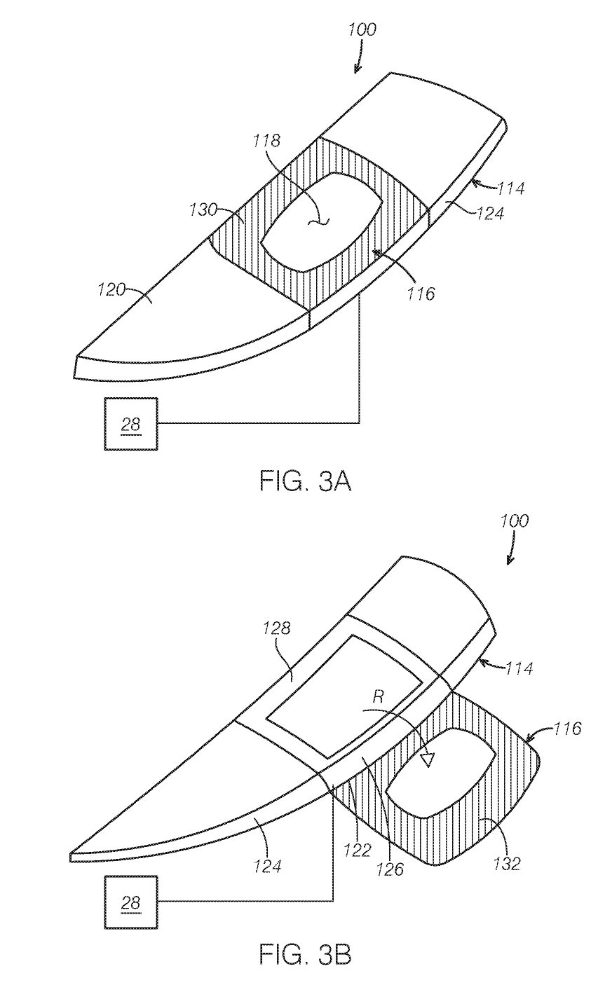

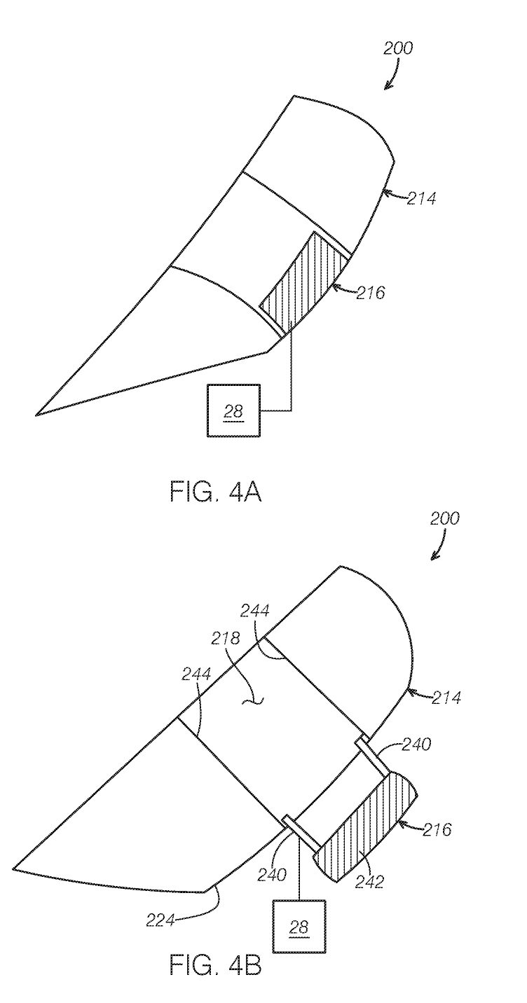

FIG. 1 shows that the auxiliary handle 16 is at the normal position. That is, the auxiliary handle 16 is not extended or projected further away from the inner surface 18 of the vehicle door 12. At the normal position, the base handle 14 may be used for opening and closing the door 12. At the deployed position, the auxiliary handle 16 is moved away from the inner surface 18 of the vehicle door 12. That is, the auxiliary handle 16 is closer to the user inside the vehicle (see FIGS. 3B and 4B for examples). The auxiliary handle 16 may be moved manually or automatically. FIG. 1 further schematically shows a control device 26 configured to control the movement of the auxiliary handle 16 and a driving device 28 connected to the auxiliary handle 16. The driving device 28 may receive instruction from the control device 26 to move the auxiliary handle accordingly.

FIG. 2 is a block diagram of a handle assembly of a vehicle door according to one embodiment of present invention. Referring to FIG. 2 and with further reference to FIG. 1, the handle assembly 10 may include a control device 26 to receive signals and a driving device 28 to move the auxiliary handle 16 based on the received actuation signal. As shown in FIG. 1, in one embodiment, the control device 26 may be integrated in a control system of the vehicle, such as an electronic control unit. In some embodiments, the control device 26 may be a single unit disposed on the base. The control device 26 may be a computing device including a process and a memory to execute a routine to operate the handle assembly 10. It should be appreciated that the control device 26 may be disposed at any appropriate positions such as in an engine compartment, or integrated in a door of a vehicle. The driving device 28 may connected to the auxiliary handle 16. In some embodiments, the auxiliary handle 16 may be rotated from the normal position to the deployed position or vice versa. The driving device 28 may be a motor to enable the rotation of the auxiliary handle 16. In some embodiments, the auxiliary handle 16 may translate from the normal position to the deployed position and vice versa. The driving device 28 may include a motor and a gear unit to enable the linear movement of the auxiliary handle 16 or the driving device 28 may be a step motor. In some embodiments, the auxiliary handle 16 may be connected to the base 20 by a spring hinge. The driving device 28 may be a device that is capable of rotating the spring hinge.

The control device 26 and the driving device 28 may be powered by a vehicle power source such as an internal combustion engine or a battery. Further, the control unit 26 may be communicated with the driving device 28, various sensors and the auxiliary handle 16, via wired connection or wireless connection. The control device 26 may control the auxiliary handle 16 to move from the normal position to the deployed position based on information from one or more sensors. At the deployed position, the auxiliary handle 16 is closer to an interior of the vehicle than at the normal position (i.e., the auxiliary handle 16 is further away from the inner surface 18 of the vehicle door 12). Thus, it is easy for the user to grab the auxiliary handle 16 to open and close the vehicle door or operate the vehicle door.

The auxiliary handle 16 may be connected to the base 20 and moveable at the deployed position and the normal position relative to the base 20. When the door is at an opening state, the auxiliary handle 16 moves to the deployed position if the user needs an assistance to close the door. As the auxiliary handle 16 is closer to the interior of the vehicle at the deployed position than at the normal position, it is easy for the user to grab the handle to close the door. The auxiliary handle 16 may be moved by the driving device 28 based on instructions or commands from the control device 26 such that the auxiliary handle 16 can automatically switch between the normal position to the deployed position, which is more convenient to the user.

Referring to FIG. 2, the handle assembly 10 may further include various sensors to send signals to the control device 26 such that the control device 26 can control the auxiliary handle 16 to move from the normal position to the deployed position or vice versa based on the received signals. Thus, the retraction or deployment of the auxiliary handle 16 can be controlled automatically.

In some embodiments, the handle assembly 10 may further include a locking sensor 30 to detect a door condition of the vehicle door 12 and communicate with the control device 26. The locking sensor 30 may be disposed on the vehicle door 12 or any other appropriate places of the vehicle. The locking sensor 30 may be a sensor dedicated to the handle assembly 10 or may be a sensor to check the door state and communicate with other control systems of the vehicle. The door locking sensor 30 may send the signal to the control device 26 to indicate that the vehicle door is at the opening state. The control device 26 may control the auxiliary handle 16 to move to the deployed position when receive the information that the door is opened. When the vehicle door 12 is closed, there is no need for the auxiliary handle 16. The auxiliary handle 16 may be driven to the normal position on the base 20 such that the auxiliary handle 16 will not take a space in the interior of the vehicle. In some embodiments, when the locking sensor 30 detects that that the door condition is changed from an unlocked state (i.e., an open state) to a locked state (i.e., a closed state), the control device 26 controls the auxiliary handle 16 to move to the normal position from the deployed position. In one example, the control device 26 may control the auxiliary handle 16 to move to the normal position from the deployed position based on the door condition and other information. For example, the control device 26 may issue a command to move the auxiliary handle 16 back to the normal position when it is determined that the door is closed and the auxiliary handle 16 has been in the deployed position for a predetermined time.

It should be understood that the action of restoring the auxiliary handle 16 to the normal position or deploying the auxiliary handle 16 may be activated by other operation components such as buttons disposed on the vehicle door 12 or a center console. Alternatively, the auxiliary handle 16 may be restored or deployed manually by the user.

The handle assembly 10 may further include a detection unit 32 to detect user information, and send a signal to the control device 26. In some embodiments, the detection unit 32 is configured to send the signal to activate the auxiliary handle 16 when it detects that a predetermined condition is met. In some embodiments, the control device 26 receives the user information from the detection unit 32 and determine whether to deploy or restore the auxiliary handle 16.

In some embodiments, the user information includes whether a user occupies or sits on a seat. In one embodiment, the detection unit 32 includes a sensor to detect occupancy of a seat. The sensor sends a signal when it detects a driver or a passenger sits on the seat. In some embodiment, when the control device 26 receives a signal that the seat is occupied from the detection unit 32 and a signal that the vehicle door 12 is open from the door locking sensor 30, the control device 26 may control the drive device 28 to move the auxiliary handle 16 to the deployed position. Subsequently, when the control device 26 receives the signal that the door is closed or is changed from an open state to a closed state, the control device 26 may control the drive device 28 to move the auxiliary handle 16 to the normal position.

In some embodiments, the user information may include information to a stature of a user. The detection unit 32 may include a sensor to detect information related to the user stature. The control unit 26 may store various threshold values such as a threshold pressure of a seat, a threshold of occupied area of a seat or a threshold mass. For example, the detection unit may a sensor such as a weight sensor or a pressure sensor to detect a weight, a pressure applied to the seat by a user and an occupied area of the user on the seat. Such user information may correlate with a stature of the user. The control device 26 may receive the user information from the weight sensor, the pressure sensor, or other sensors compare them with threshold values to determine whether the auxiliary handle 16 needs to be activated. For example, the control device 26 may determine that the user can reach the base handle 14 easily and there is no need to actuate the auxiliary handle 16 when the user information indicates that the user has a large stature. The control device 26 may determine that the user has difficult to reach the base handle 14 and the auxiliary handle 16 needs to be deployed when the user information indicates that the user has a small stature. In some embodiments, some conditions need to be met for deployment of the auxiliary handle 16. The pressure sensor or the weight sensor may be disposed in a seat cushion. It should be understood that the sensor may be any appropriate sensors to detect the user information and may be disposed at any positions of the seat such as, disposed in a seat cushion, a seatback or a headrest of the seat because the sensor detects the condition or the change of the condition of the seat. It further should be understood that the position and type of the sensors do not constitute any limits to the invention. Further, the control device 26 may communicate with an occupant classification system of the vehicle to obtain the user information.

In some embodiments, the control device 26 may communicate with a mobile terminal such as a smart phone held by the user to adjust the auxiliary handle 16 to a position preferred for the user. It should be understood that adjustment of the auxiliary handle 16 may be performed before or after the user enters the vehicle. In some embodiments, the handheld devices or mobile terminals communicated with the vehicle may be used as the detection unit 32. The handheld device is independent from the vehicle, and contain the user identification. Under some situations, when remotely starting a vehicle with a handheld device, the control device 26 receives the user identification and obtain the information related to the user stature and control the auxiliary handle 16 accordingly.

In some embodiments, the detection unit 32 may include an image sensor disposed in an interior of the vehicle. For example, the image sensor may be a surveillance camera or a vision sensor such as a retina sensor to identify the user. In some embodiments, the detection unit 32 may be a fingerprint detector or a hand palm detector which is configured to identify the user. When the image sensor, the finger detector or the hand palm detector detects that a user has entered the vehicle and sit on the seat, the information is sent to the control device 26.

In some embodiments, the control device 26 may store reference data or images. When the control device 26 receives the captured image of a user by the image sensor such as a surveillance camera or a vision sensor (e.g., a retina detector), it compares the captured image with the reference images. When a stature or a ratio of the captured image is bigger than the reference image, the control device 26 may determine that the user may have a large stature and further determine that the auxiliary handle 16 does not need to be actuated. If the stature or the ratio of the captured image is smaller than the reference image, the control device 26 may determine that the user has a relative small stature, and the auxiliary handle 16 needs to be deployed to assist the user.

Similarly, for the handle assembly including a detection unit 32 such as a vision sensor, a retina detector, a fingerprint detector, or a hand palm detector, the user information may be stored in the control device 26 or a vehicle control system. For example, the information of a first user with a larger stature and a second user with a smaller stature are stored in a look up table of the control device 26 or the vehicle control system. When the first user enters the vehicle, the detection device detects the user's image, retina, fingerprint, or hand and the control device 26 searches the look up table. When match information is found, the control device 26 may determine that the first user does not need the auxiliary handle 16 to be deployed for assistance. When the second user enters the vehicle, the detection device detects the user's image, retina, fingerprint, or handprint and the control device 26 searches the look up table. When match information is found, the control device 26 may determine that the second user needs the auxiliary handle 16 to be deployed for assistance.

It should be understood that the detection unit 32 is not limited to the embodiments described above. In other words, the detection unit 32 maybe any device that detects the user information, and send the information to the control device 26 such that the control device can determine how to operate the auxiliary handle 16. It also should be understood that all embodiments described above or below may be combined to form new embodiment. For example, the seat of the vehicle may include various sensors. An image sensor or a haptic detector may be disposed inside the vehicle to determine the user information.

The control device 26 can control the auxiliary handle 16 automatically to deploy or retract. Further the control of the auxiliary handle 26 may be operated by the control device 26 based on the information from the detection unit 32 and/or the locking sensor 30. In this way, an automation is achieved via interaction of the control device 26, the locking sensor 30, the detection unit 32 and the drive device 28 such that the user does not need to operate the handle manually.

Additionally or alternatively, in one embodiment, the detection unit 32 may include a proximation sensor disposed on the base handle 14 or the auxiliary handle 16. In one embodiment, when a user sits on the seat and reaches out his/her arm toward the base handle 14, the proximation sensor may detect a distance between the arm and the base handle 14. If the distance is less than the predetermined threshold, the control device 26 may determine that the user can reach the base handle 14. If the distance is greater than the predetermined value, the control device 26 may determine that the user may not be able to reach the base handle 14 and the auxiliary handle 16 needs to be deployed to assist the user. In some embodiments, the control device 26 may be configured to deploy the auxiliary handle 16 from the normal position once the proximation sensor detects the user's arm reaches out toward the base handle 14. In some embodiments, the auxiliary handle 16 may be deployed when the proximation sensor detects that the arm keeps a distance with the handle 14 in a certain time (such as 1 second or another proper period time). When a threshold time value is exceeded, the control device 26 may determine that the user has a difficult to reach the base handle 14, and an assistance needs to be provided.

Continuing with FIG. 2, in some embodiments, the handle assembly 10 may further comprise an actuator 22. The actuator 22 may be connected to the control device 26 to send the signal to activate the auxiliary handle 16. For example, the actuator 22 may be configured as a supplement unit to the detection unit 32 or may operate independently. When the user has a larger stature, the control device 26 may determine that the user does not need the auxiliary handle 16 to be deployed for assistance. However, under some situations, such as in winter, the user in a heavy coat may have difficult to operate the base handle 14. The user can press the actuator 22 to send an actuation signal to the control device 26, and the control device 26 deploys the auxiliary handle 16 after receiving the actuation signal. Therefore, the actuator 22 makes the handle assembly 10 versatile in its operation.

In some embodiments, the actuator 22 may be a button disposed at any appropriate positions. For example, the actuator 22 may be disposed in an interior of the vehicle, such as an instrument panel, a center console, or a vehicle door. The actuator 22 may also be integrated on a smart key of the vehicle. In some embodiments, the actuator 22 may be an audio unit to receive a voice or instructions from a user. The control device 26 may be configured to recognize the voice or the instruction and control the driving device 28 accordingly. In some embodiments, the actuator 22 may be an image sensor configured to capture a hand gesture. The control device 26 may be configured to recognize the hand gesture and control the driving device 28 accordingly. Referring to FIG. 2 again, the control device 26 is further configured to command or control the driving device 28 to move the auxiliary handle 28 based on the signal from one of the detection unit 32, the locking sensor 30 and the actuator 22.

FIGS. 3A and 3B schematically show a partial handle assembly 100 according to one embodiment of the present disclosure. The handle assembly 100 includes a base 114 and an auxiliary handle 116. The auxiliary handle 116 may be a plate including an opening 118. That is, the auxiliary handle 116 has a looped structure. The opening 118 may be configured to receive a hand or fingers of a user. The base 114 may include an aperture corresponding to the opening 118 of the auxiliary handle 116. The auxiliary handle 116 may be disposed on an upper surface 120 of the base 114. The opening 118 may be configured to expose the aperture of the base 114. One side 122 of the auxiliary handle 116 may be pivotally connected to a distal end 124 of the base 114. The distal end 124 may refer to an edge portion of the base 114 that is spaced away from an inner surface of a vehicle door. In some embodiments, the auxiliary handle 116 may be connected to the base 114 via a hinge mechanism. In some embodiments, the auxiliary handle 116 may be connected to the distal end 124 via a pivot 126. In some embodiments, the auxiliary handle 116 may be connected to the distal end 124 via a spring hinge. The base 114 may be attached to an inner surface of the vehicle door. Alternatively, the base 114 may be a base of a base handle of the vehicle (e.g., the base handle 16 in FIG. 1).

The auxiliary handle 116 may further be connected a drive device 28. In some embodiments, the drive device 28 is a motor. Upon a command from a control device, the driving device 28 rotates the auxiliary handle 116 from a normal position as shown in FIG. 3A to a deployed position as shown in FIG. 3B at a direction R or vice versa At the normal position, the auxiliary handle 116 rests upon the inner surface 120 of the base 114. In some embodiments, the base 114 may include a recess 128 surrounding the opening 118 to receive the auxiliary handle 116. At the normal position as shown in FIG. 3A, a surface 130 of the auxiliary handle 116 may be substantially aligned with the upper surface 120 of the base handle 114. At the deployed position shown in FIG. 3B, a free end 132 of the auxiliary handle 116 is closer to the user or the auxiliary handle 116 is closer to the user.

FIGS. 4A and 4B schematically show a partial handle assembly 200 according to another embodiment of the present disclosure. The handle assembly 200 includes a base 214 and an auxiliary handle 216. The auxiliary handle 216 may include two legs 240 and a cross bar 242 connecting the two legs 240. Each of the two legs 240 is moveably connected to a sidewall 244 that forms a cavity 218 of the base 214. The base 214 may be attached to an inner surface of the vehicle door. Alternatively, the base 214 may be a base of a base handle of the vehicle (e.g., the base handle 16 in FIG. 1).

The legs 240 are driven by a driving device 28 such that the auxiliary handle 216 can extend and retract between a deployed position as shown in FIG. 4B and a normal position as shown in FIG. 4A. In some embodiments, the driving device 28 may include a motor and a gear device to convert a rotation to a linear movement. In some embodiment, the driving device 28 may include a step motor. The driving device 28 may be disposed on the vehicle door or any appropriate locations. It should be appreciated that the auxiliary handle and the driving device may have any appropriate configuration capable of switching the auxiliary handle between a normal position to a deployed position.

In some embodiments, the auxiliary handle 14, 114, 214 may further be configured to maintain different deployed positions. For example, the auxiliary handle 14, 114 and 214 may be configured to move between a normal position, a first deployed position, and a second deployed position between the first deployed position and the normal position. As the users have different statures or different habits of grabbing the handle, the handle assembly may be configured to provide different deployed positions. The driving device 28 may include a step motor to drive the auxiliary handle to different deployed position and return to the normal position.

Turning back to FIG. 1, the handle assembly 10 is illustrated with a door at a driver side. It should be understood that the handle assembly 10 can be positioned at a side of a driver, a front seat passenger or a rear seat passenger. In some embodiments, a seat corresponding to a door having the handle assembly may include a detection unit 32. The detection unit 32 is configured to detect an occupation state of the seat and send the signal to the control device 26. In other words, the door including an auxiliary handle 16 is communicated electrically to the seat having a detection unit 32 via wire or wireless to receive a signal. The control device 26 of the handle assembly 10 can command the driving device 28 to drive the auxiliary handle 16 based on the received signal. That is, the door having a handle assembly and the seat corresponding to the door and having detection unit are correlated to realize the corresponding detection and operation.

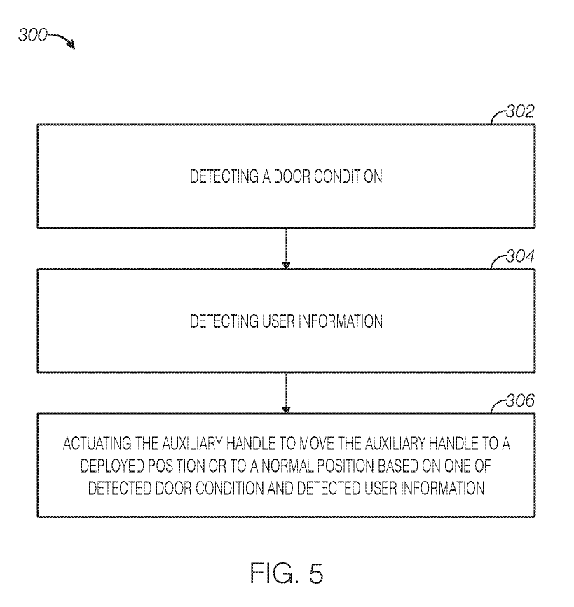

FIG. 5 is a flow chart of a method 300 to operate an auxiliary handle of a door of a vehicle. The method 300 includes detecting a door condition at 302. Detecting the door condition may include detecting an opening state or a closed state of the door by a locking sensor. At 304, the method 300 may include detecting user information by a detection unit. The user information may include information related to a length of an arm of a user such as a stature of the user, a position of a user's hand, and whether a user sits on a seat. The detection unit may be the detection unit described above or may be any appropriate detection unit. For example, the detection unit may be an image sensor to obtain information related the stature of the user, the hand position and whether the user has sit on the seat. In another example, the detection unit may be a proximation sensor to determine the hand position. In yet another example, the detection unit may be a weight sensor or a pressure sensor disposed on the seat, a retina detector, a finger print detector, a hand palm detector, or a mobile terminal. In another example, the detection unit may be sensors from an occupant classification system of the vehicle. The method 300 receive the user information such as a stature of the user from the occupant classification system.

At 306, the method 300 may include actuating the auxiliary handle to move the auxiliary handle to a deployed position or to a normal position based on one of detected door condition and detected user information. The method 300 may actuating the auxiliary handle to move the auxiliary handle to the deployed position when it determines that the door is opened based on a signal from a locking sensor. In another example, the method 300 may include actuating the auxiliary handle to move the auxiliary handle to the deployed position when it determines that the door is open and a user has sit on a seat corresponding to the auxiliary handle. In another example, the method 300 may include actuating the auxiliary handle to move the auxiliary handle from the deployed position to the normal position when it determines that the door is locked and a user has sit on the seat corresponding to the auxiliary handle. In another example, the method 300 may actuate the auxiliary handle based on detected hand movement of the user.

In yet another example, the method 300 may actuating the auxiliary handle when it determines that a user has a small stature based on information from the detection unit.

The handle assembly of a vehicle according to one or more embodiment of the present disclosure activates an auxiliary handle based on one of the door condition and the user information. Thus, the auxiliary handle can be used based on the need of the user.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions.

It will be appreciated that the configurations and routines disclosed herein are exemplary in nature, and that these specific embodiments are not to be considered in a limiting sense, because numerous variations are possible.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

1. A handle assembly of a door of a vehicle, comprising:
an auxiliary handle, wherein the auxiliary handle is disposed on an inner surface of the door, and moveable between a deployed position and a normal position;
a driving device to move the auxiliary handle; and
a control device configured to instruct the driving device to move the auxiliary handle based on a door condition.

2. The handle assembly of claim 1, further comprising a base on the inner surface of the door, wherein the base includes a cavity in a middle portion to receive a hand, and wherein the auxiliary handle is disposed on the base at the normal position and extended away from the base at the deployed position.

3. The handle assembly of claim 1, further comprising a locking sensor to detect the door condition, wherein the control device is configured to instruct the driving device to move the auxiliary handle based on an open state and a closed state of the door.

4. The handle assembly of claim 3, further comprising a detection unit to detect user information, wherein the user information includes whether a user sits on a seat corresponding to the auxiliary handle.

5. The handle assembly of claim 4, wherein the detection unit is one of a weight sensor and a pressure sensor disposed on a cushion of the seat to obtain information related to a user stature.

6. The handle assembly of claim 4, wherein the detection unit includes an image sensor to capture an image of user and the control device is configured to estimate a stature of a user based on a captured image from the detection unit.

7. The handle assembly of claim 4, wherein the control device is configured to instruct the driving device to move the auxiliary handle to the deployed state when it determines that the door is at the open state and instruct the driving device to move the auxiliary handle from the deployed position to the normal position when it determines that the door is changed from the open state to the closed state and the user has sit on the seat based on the information from the locking sensor and the detection unit.

8. The handle assembly of claim 1, further comprising an actuator connected to one of the control device and the driving device, wherein the actuator is configured to activate movement of the auxiliary handle upon an action from the user.

9. The handle assembly of claim 8, wherein the actuator is disposed on a base of the handle, the door or is integrated on a key fab of the vehicle.

10. The handle assembly of claim 2, wherein the auxiliary handle includes a plate having an opening and pivotally connected to the base handle at a side closer to an interior of the vehicle by a spring hinge and wherein the auxiliary handle is rotated between the deployed position and the normal position by the driving device.

11. The handle assembly of claim 11, wherein the auxiliary handle includes two legs and a cross bar between the two legs and wherein the two legs are slidable along an inner surface of the cavity of the base, wherein the driving device includes a step motor to extend and retract the auxiliary device between the normal and the deployed positions.

12. The handle assembly of claim 4, wherein the detection unit is a proximation sensor to detect a hand of a user, and the proximation sensor is disposed on the handle.

13. The handle assembly of claim 1, wherein the auxiliary handle is further configured to move between one of the deployed position, the normal position and a middle position between the deployed position and the normal position.

14. The handle assembly of claim 1, wherein the auxiliary handle is closer to a user sitting on a seat at the deployed position.

15. A method to operate an auxiliary handle of a handle assembly of a vehicle door, comprising:
detecting a door condition; and
actuating the auxiliary handle to move the auxiliary handle to a deployed position or a normal position based on a detected door condition.

16. The method of claim 15, wherein detecting the door condition includes detecting an opening state or a closed state of the door.

17. The method of claim 16, wherein actuating the auxiliary handle includes move the auxiliary handle to the deployed position when it is determined that the door is opened.

18. The method of claim 15, further comprising detecting user information, wherein actuating the auxiliary handle is further determined based on detected user information.

19. The method of claim 18, wherein the user information includes a stature of a user.

20. The method of claim 19, wherein the user information includes whether the user sits on a seat of the vehicle corresponding to the auxiliary handle.
